(19) United States
(12) Patent Application Publication
(10) Pub. No.: US 2020/0122102 A1
(43) Pub. Date: Apr. 23, 2020

(54) ULTRASONIC CAVITATION METHOD AND MIXER FOR OIL-BASED BOTANICAL EXTRACTS

(71) Applicant: David M. Tumey, Coral Springs, FL (US)

(72) Inventor: David M. Tumey, Coral Springs, FL (US)

(73) Assignee: Bluegrass Farmaceuticals, LLC, Belton, KY (US)

(21) Appl. No.: 16/600,588

(22) Filed: Oct. 14, 2019

Related U.S. Application Data
(60) Provisional application No. 62/747,427, filed on Oct. 18, 2018.

(51) Int. Cl. B01F 11/02; B01F 11/00

(52) U.S. Cl. CPC B01F 11/0258; B01F 11/004; B01F 11/0291

(57) ABSTRACT

An ultrasonic mixing apparatus and method is provided for cavitation and processing an aqueous first fluid with an oil-based second fluid, e.g., cannabinoids in a sonication or cavitation zone. The apparatus can be used for preparation of nano-particle emulsions of oil-based botanical extracts in aqueous fluids for therapeutic consumption. The apparatus is effective in producing increased bioavailability of the botanical extract due to the small particle size created through cavitation.

### FIELD OF THE INVENTION

The present general inventive concept relates to an ultrasonic mixing apparatus and method, and in particular the invention relates to an ultrasonic fluid processing method for mixing oil-based botanical extracts, e.g., cannabinoids in an aqueous solution which uses vibration means and a cell with a plurality of concentric flow paths with openings so disposed as to provide materials to be processed simultaneously into a sonication or cavitation zone.

### BACKGROUND OF THE INVENTION

The basic problem is one of intermixing two or more immiscible fluids, for example, mixing a plurality of fluids, i.e.: intimately mixing an oil-based solution in an aqueous-based solution, a gas in a liquid, or a liquid in another liquid, or more than two phases, with accurate control of the passage of the two (or more) phases through the active portion of the device in which such mixing takes place. Secondarily and more specifically, the problem is to prepare emulsions for chemical and pharmaceutical applications, to gasify liquids for purification and for chemical reactions, to accelerate physical and chemical reactions, and to suspend fine particles. Another problem is to intimately mix two reactive materials rapidly as they enter a cavitation field. In many of the foregoing, it is also critical to control the atmosphere in which these processes take place, or to exclude a particular undesired atmosphere. Fluids to which reference is made herein may or may not include embedded solid particles.

Myriad references generally describe four distinct application methodologies. The first methodology (1) was the placement of the immiscible fluids in the tank of an ultrasonic cleaning bath or similar cavitating open vessel, as described quite extensively in early publications, such as “Ultrasonics . . . Science of a Coming Technology” (unattributed), in Industrial Laboratories, April 1952, and “Ultrasonically Induced Cavitation in Water” by G. W. Willard of the Bell Telephone Laboratories, in the Journal of the Acoustical Society of America, Volume 25, No. 4, Pp. 669-686, July 1953, and in U.S. Pat. Nos. 3,351,539 and 4,576,688. A further development of this methodolgy was the closure of the tank or vessel such that liquid could flow in a controlled manner in and out of the energy field, usually accompanied by provision of additional radiating surfaces to increase the intensity of the ultrasonic energy field, as described in Heat Systems-Ultrasonics, Inc. Technical Note HSU-TN-1, “Industrial Scale Ultrasonic Liquid Processing”, dated April 1984. A second methodology (2) was the introduction into a static bath containing two or more immiscible fluids, of an ultrasonic horn vibrating at sufficiently high amplitude and frequency to generate cavitation, the creation of shock waves in liquid by formation and collapse of vapor bubbles, as described in U.S. patents such as U.S. Pat. No. 3,246,881. A further development of this technique was the enclosure of the horn tip and liquid bath in a pressure vessel with inlet and outlet provisions, thereby allowing pressurization of the bath and continuous flow of the liquid and other fluids, as described in Heat Systems-Ultrasonics, Inc. brochure S-803 dated May 1962 and in U.S. Pat. Nos. 3,394,274; 3,715,104; and 4,244,702. The third methodology (3) was the passage of the fluids past a vibrating sharp edge or reed by which means cavitation was induced in the primary liquid, as described in Bulletin 60 from Sonic Engineering Corp. and in literature covering the SONOLATOR device from Sonic Engineering Corporation. The fourth methodology (4) was the forcing of fluids at extremes of pressure through greatly restricted orifices such that very high shear forces were generated in the primary liquid, resulting in cavitation, as described in literature from APV-Gaulin Corp. One of many methods of purifying water through the introduction of ozone is discussed in U.S. Pat. No. 4,548,716, while one of many methods of purifying liquids and other substances by the application of ultrasonic energy is discussed in U.S. Pat. No. 4,477,357.

Past methods and methodologies are shown and described in Reprint PVI-2 entitled “Application of Ultrasonic Liquid Processors (Power vs. Intensity in Sonication)”, by S. Berliner, III, dated April 1985, available from Heat Systems Incorporrated, 1938 New Highway, Farmingdale, N.Y. 11735, which describes typical equipment and applications; in “The Chemical Effects of Ultrasound”, Pp. 80-86, SCIENTIFIC AMERICAN, February 1989, by Dr. Kenneth S. Suslick, which describes processes; and in Bulletin S-803, entitled “New Branson SONIFIER”, available from Branson Instruments, Inc., which describes an ultrasonic mixing apparatus.

The problems with the previous methodologies lie in (1) assuring uniform treatment of all aliquots or fractional parts of the fluid media being processed, (2) assuring that the proportions of the phases are accurately maintained during processing, (3) assuring that equal amounts of all phases are present in the energy field at all times during processing, (4) avoiding extremes of pressure in order to minimize the great danger presented by such pressure, and (5) controlling or excluding the atmosphere in which processing occurs. A major drawback in the use of parallel plate transducers, and in cylindrical or polygonal transducers, which radiate inwards toward the longitudinal center of a flow path is that there are “dead” zones, places where vibrations null each other through cancellation.

The method of this invention differs from the previously described methods in that this method uses concentric delivery passages or tubes through which the fluids are introduced into a high-intensity energy field in which cavitation is induced in the primary liquid. The major advantage offered by this configuration is that the two (or more) parts of a fluid, are not brought into contact in any way outside of the sonication field. Injecting one part through, for example, an outer tube while injecting another part through an inner tube brings them into the sonication zone simultaneously. The central origin and radial flow assures uniform processing of all aliquots, unlike the situation which pertains with the current devices.

As described in greater detail in the references by Berliner and by Suslick hereinbefore cited, the action of ultrasound in a liquid with very high intensity results in the repeated rapid formation and extremely violent collapse of bubbles, generating shock waves which radiate throughout the liquid, a process known as cavitation or sonication. The collapse of the bubbles and passage of shock waves through a liquid containing other liquids, immiscible in the parent liquid, or gases or fine solid particles results in mixing, emulsification, gasification, deagglomeration and disaggregation, suspension and dispersion, and even the creation of new compounds unobtainable by other means. This comes about from the high pressure and temperature generated in the collapse and in the passage of the shock wave and related effects, in which theoretical values of 10,000 atmospheres and 20,000° K. may obtain and in which actual values of at least 500 atmospheres and 5,500° C. have been calculated (Suslick, op. cit.). These intense energy levels created by the explosive sonication provide the means whereby the processes described can be enhanced and accelerated. Precise control of the introduction into, and passage through, the cavitation or sonication field or zone of the materials to be processed becomes more critical as the intensity increases. The present general inventive concept provides a superior method of achieving optimum results in a manner not hitherto practiced with respect to the mixing of oil-based cannabinoids in an aqueous solution.

### SUMMARY OF THE INVENTION

According to the present general inventive concept, an ultrasonic fluid processing apparatus and method for mixing two or more immiscible fluids is provided. In a preferred embodiment, this method includes the steps of: forming a vibration face with an axis for disposing a sonication or cavitation zone adjacent to and coaxially with the vibration face; enclosing the vibration face and sonication zone in a sealed cavity having a first fluid passage; forming a second fluid passage coaxially with the vibration face and disposed adjacent to the sonication zone; and forming a third fluid passage coaxially with the vibration face and disposed adjacent to the sonication zone.

By using the sonication or cavitation zone and two coaxial fluid passages, the problems with the control of proportions and amounts and uniformity of the inlet fluids, and parts thereof, are avoided.

The invention provides an ultrasonic fluid processing method for cannabis and products derived therefrom, including the steps of providing a sonication zone, providing a vibrational surface within said sonication zone, providing a cannabinoid oil in a first fluid into the sonication zone, providing a second fluid material into the sonication zone which is generally immiscible with the cannabinoid oil, and energizing the vibrational surface to cause ultrasonic cavitation and thereby break up the cannabinoid oil into nano-particles in the second fluid material creating an emulsion. The vibrational surface and sonication zone are in a sealed cavity having a first fluid passage receiving the first fluid adjacent the vibrational surface and a second fluid passage receiving the second fluid about the first fluid in the sonication zone, and an outlet.

In a preferred embodiment, the second fluid includes water and the first fluid further includes a terpene. In another embodiment, the first fluid further includes a flavonoid.

The foregoing and other objects, features and advantages will be apparent from the following description of the embodiments of the present general inventive concept as illustrated in the accompanying drawings.

### BRIEF DESCRIPTION OF THE DRAWINGS

FIG. 1 is a perspective view of a first embodiment or system using the method according to the invention;

FIG. 2 is an elevation view as taken along line 2-2 of FIG. 1;

FIG. 3 is a section view as taken along line 3-of FIG. 1;

FIG. 4 is an enlarged view of a portion of FIG. 3;

FIG. 5 is a section view, corresponding to FIG. 3, of a second embodiment using the invention;

FIG. 6 is a schematic section view, corresponding to FIG. 3, of a third embodiment using the invention;

FIG. 7 is a schematic section view, corresponding to FIG. 3, of a fourth embodiment using the invention;

FIG. 8 is a schematic section view, corresponding to FIG. 3, of a fifth embodiment using the invention; and

FIG. 9 is a schematic section view, corresponding to FIG. 3, of a sixth embodiment using the invention.

### DETAILED DESCRIPTION OF THE PREFERRED EMBODIMENT

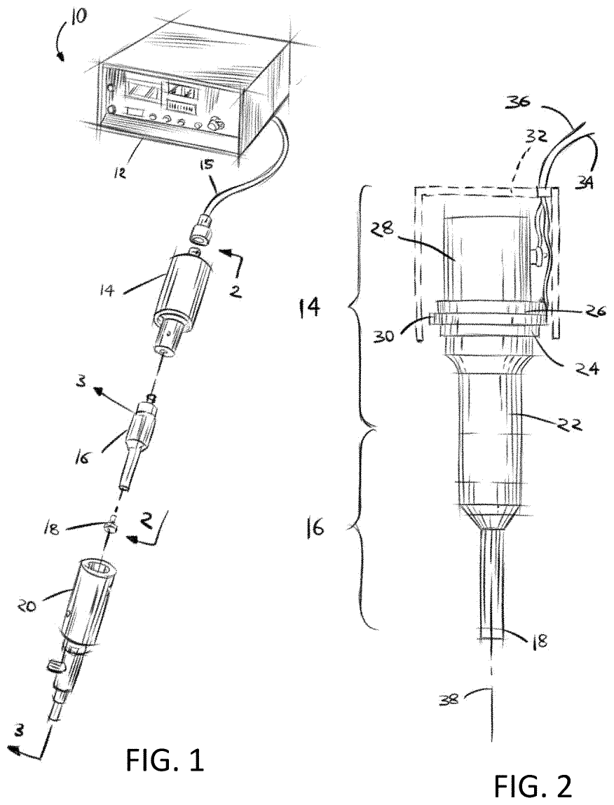

As shown in FIGS. 1 and 2, a first embodiment, or system, or configuration 10, which makes use of the present general inventive concept, is provided. System or configuration 10 includes a generator 12, a converter 14 with a cable 15, a horn 16, which has a flat tip 18, and a cell 20. In the embodiment shown, converter 14 has a front driver 22, lower transducer crystal 24, an upper transducer crystal 26, and a back driver 28. Converter 14 also has a center electrode 30, an enclosure 32, a first lower wire 34, a second upper wire 36. Converter 14 and horn 16 have a common axis 38.

Generator 12, which is an ultrasonic power supply, transforms power from an electrical source to that required to energize and control the converter 14. Converter 14, which is an ultrasonic converter, or transducer, or power head, connects to horn 16. Converter lower crystal 24 and upper crystal 26, which are piezoelectric crystals, resonate in an axial direction, along axis 38. Crystals 24 and 26 are prestressed and fitted between front driver 22 and back driver 28. Front driver 22, back driver 28, crystals 24, 26, and electrode 30, form a subassembly, which is called an ultrasonic stack, and which is a resonant body. Energy, typically up to 1,000 volts, is conducted to crystals 24, 26 by center electrode 30. Wires 34, 36, which connect to center electrode 30 at the ends thereof, connect to cable 15 at the other ends thereof. Cable 15 is a shielded coaxial high frequency cable. Horn 16 and front driver 22 are mechanical vibration amplifiers the gain of which is determined by their geometry. Enclosure 32, which is a housing, encloses and isolates the upper part of converter 14, both of which are electrically and mechanically active. Horn 16 has a free resonant action, during operation thereof. The connection between horn 16 and cell 20 is such that it does not affect the free resonant action of horn 16. Horn 16 causes cavitation in fluid passing through cell 20 as ultrasonic energy is imparted thereto. There is provided a vibrational surface which comprises cylindrical horn 16. It is envisioned the horn 16 can be stepped or parabolic. The vibrational surface can be oscillated in the range of 19 to 25 kilohertz, with a preferred range of 39 to 50 kilohertz. Further, the vibrational surface can include a piezoelectric transducer and high-frequency generator which produces ultrasonic oscillations in the range of 30 to 150 watts.

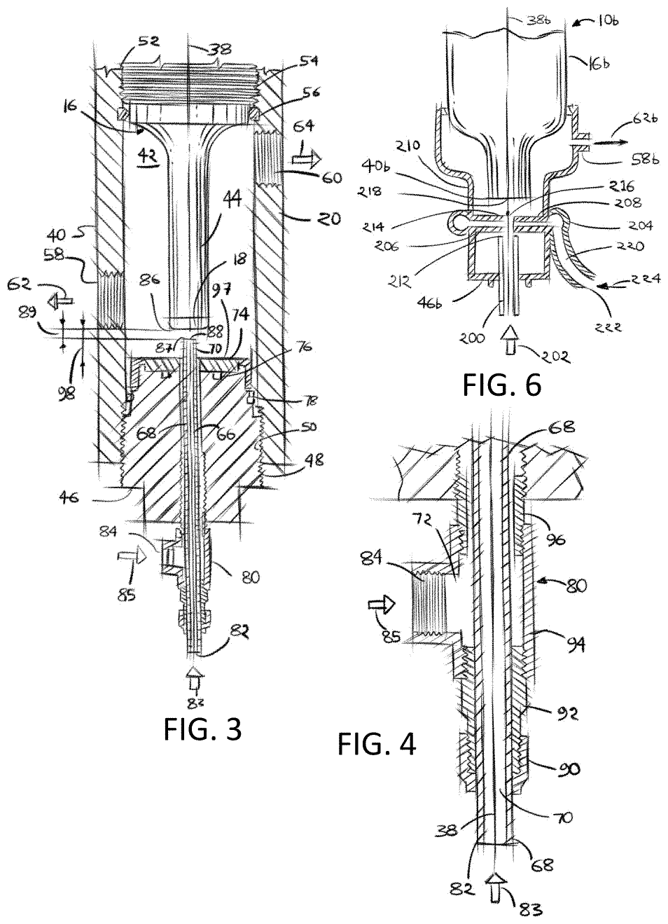

As shown in FIGS. 3 and 4, cell 20 is coaxial with horn 16 along axis 38. Cell 20 has a peripheral wall or housing wall 40, which encloses a cavity 42. Horn 16 has an extended stem portion 44, which supports tip 18. Cell 20 has a bottom end wall 46 with external threads 48, which are received by internal threads 50 of wall 40. Horn 16 also has external threads 52, which are received by internal threads 54 at the top of wall 40. Horn 16 has a ring seal 56, which is disposed adjacent to threads 52, 54. Peripheral wall 40 has a main outlet opening 58 and an auxiliary outlet opening 60. Opening 58 has a flow direction 62, and opening 60 has a flow direction 64. End wall 46 has a wall or tubular portion that has an elongate hole 66, which receives an elongate tube 68, thereby forming an inner passage 70 and an outer passage 72. Passages 70, 72 are concentric about axis 38.

End wall 46 has a two-part integral cap member 74, which has a relatively small diameter ring seal 76. End wall 46 has a relatively large diameter ring seal 78, disposed adjacent to threads 48, 50. Tube 68 is supported by a pipe assembly 80, which has a side inlet opening 84, that has a flow direction 85, and which further connects to passage 72. Tube 68 has a bottom inlet opening 82, which has a flow direction 83, and which further connects to inner passage 70. Tip 18 has a flat end face 86, which faces tube 68 at its end, forming therebetween a gap 89. Pipe assembly 80 is additionally supported by end wall 46.

As shown in FIG. 4, pipe assembly 80 includes a lower compression sealing collar 90, which has a portion disposed over tube 68 and which has a portion threaded over a lower pipe 92. Lower pipe 92 is threaded into a T-shaped connector pipe 94, which is threaded over an upper pipe 96. Pipe 96 is threaded at its upper end into wall 46, adjacent to outer passage 72. Face 86 is also disposed opposite to face 97 of member 74 forming a gap 98. Gaps 89, 98 define a sonication or cavitation zone 88. End wall 46 together with member 74 can be disposed for adjusting the size of gap 98. Then collar 90 may be loosened to adjust the gap 89 of zone 88. In the process, housing wall 40 is connected and sealed to horn 16 providing concentric passages 70, 72, which provide concentric introduction of fluids to sonication zone 88. A primary fluid, e.g., an aqueous fluid flows through outer passage 72 to zone 88. A secondary fluid, e.g., oil-based cannabinoid flows through inner passage 70 to zone 88, which is next to flat face 86 of horn tip 18. Seals 56 and 78 retain the gas and fluid within cavity 42. The primary fluid enters opening 84 to outer passage 72. Secondary fluid enters opening 82 to inner passage 70. Outlet opening 58 carries out the processed fluids. Auxiliary outlet opening 60 removes excess gases involved in fluid processing. It will be readily understood that at least one of the fluids must be a liquid for cavitation to occur.

With this arrangement utilizing system 10, the method of manufacture and processing provides an application of high-intensity ultrasonic energy in liquid processing for intimate mixing of a fluid in a liquid, i.e.: intimately mixing an oil-based cannabinoid in an aqueous-based solution, a gas in a liquid, or a liquid in another liquid, or more than two phases, and associated effects. Related effects include shearing of materials, acceleration of physical and chemical reactions, processing biomaterials, suspending fine particles, and production of extremes of pressure and temperature. Ultrasonic energy is used for high-shear mixing, emulsification, and gasification.

Introduction of two or more reactants, components, or phases, or the like, into a cavitation field or zone results in their being broken into nanometer-sized aliquots and forced into intimate contact, e.g., an emulsion. This, in turn, produces very high surface area on which reactions can occur, which combines with extremely high localized pressures, temperatures, and shear rates. The high energy levels involved result in superior mixing, even of otherwise immiscible liquids; accelerated reactions between chemical elements and compounds, and in addition, the creation of compounds not previously obtainable through other means; enhanced sparging of gases such as oxygen or ozone which can act as purifiers for potable water; and outstanding emulsification and suspension as the shock waves resulting from the collapse of cavitation bubbles force molecules of one part through the interface into the other part and vice-versa or separate and disperse fine particles.

The material utilized in the fabrication of horn 16 is normally titanium alloy, although other materials of low acoustic impedance can and have been used, notably Monel metal. Titanium is both very strong and light, has virtually the same chemical resistance as stainless steel, and is resistant to ablation in the cavitation field. Aluminum, which has the lowest acoustic impedance of any metal, is not normally appropriate because of its low resistance to ablation in the cavitation field and high chemical reactivity. The materials utilized in manufacturing the pressure-containing housing or cell, 20, and the appurtanences 46, 80, thereto are normally stainlesss steel, with Buna-N (nitrile rubber) seals.

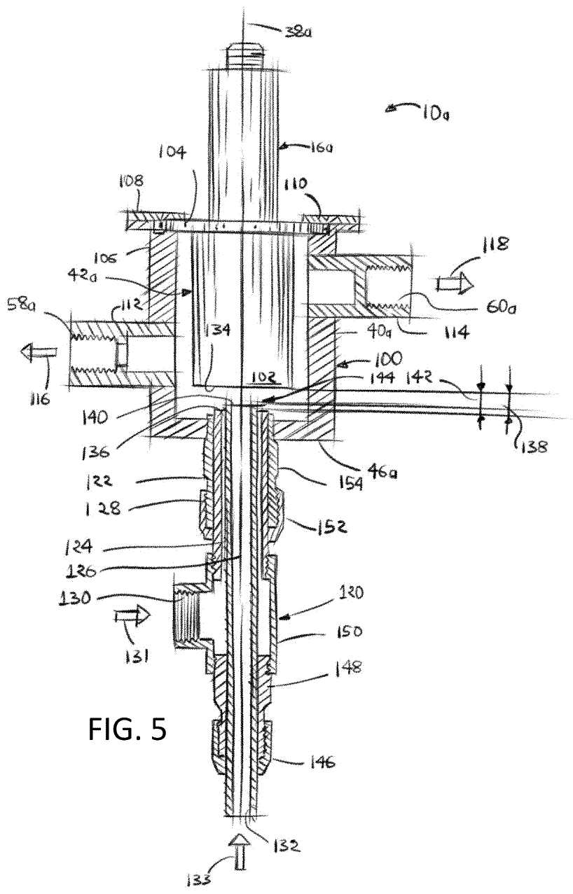

The dimensions of horn 16 are limited only by the body diameter of the horn, which, to avoid fatigue failure, is generally limited to about 3.3″ (8.4 cm). Laboratory-scale horns are typically 1.5″ (3.8 cm) in body diameter with 0.5″ (1.3 cm) to 1″ (2.5 cm) output diameters. Corresponding cell housings 40 are usually 2″ (5 cm) in diameter and about 5″ (12.5 cm) long. Length of the horn and housing is determined by the frequency at which the convertor/transducer and horn resonate, conventionally 20 kHz (20,000 cycles per second), but preferably 40 kHz. Other frequencies are also acceptable, subject to noise and efficiency considerations. The horn 16 is normally sized to one half wavelength long to achieve self-resonance, which, in aluminum or titanium at 20 kHz is nominally 5″ (12.5 cm). Cells 20, which might be used on a laboratory scale, require only approximately 500 watts and process in the range of 10 U.S. gallons (40 liters) per hour. For industrial processes, horn diameters may approach the aforementioned limit and the cell dimensions might approach or exceed 3.5″ (8.9 cm) diameter by 7″ (17.8 cm) long; such a cell, as depicted in FIG. 5, might require as much as 2,500 watts of power and process in the range of 10 U.S. gallons (40 liters) per minute. The dimensions of all other parts are proportional to those described; other than those determined by wavelength, dimensions are not critical to the present general inventive concept. Techniques exist which allow the use of horns even wider than 3.3″ (8.4 cm), usually requiring relieving the body by hollowing, resulting in a parabolic or bell-shaped horn as shown in FIG. 9. Spacing of the radiating face 86 of horn 16 from the delivery tube 68 is generally close, in the range of 0.125″ (0.32 cm) to 0.5″ (1.27 cm), but can best be determined empirically for each desired application.

A second embodiment or configuration 10a, which uses the method of the present general inventive concept, is shown in FIG. 5. Components of configuration 10a, which are the same as corresponding components of configuration 10, have the same numerals, but with a subscript “a” added thereto. Configuration 10a utilizes an industrial scale or industrial type subassembly including cell 100 and horn 16a, which are coaxial along axis 38a. Cell 100 has a peripheral wall 40a with a cavity 42a. Horn 16a has an enlarged output section 102 and an integral annular top flange 104. Cell 100 has a recess 106 and ring 108 with screws 110 to position and secure flange 104. Cell 100 has a bottom end wall 46a which is integral with peripheral wall 40a. Peripheral wall 40a has an integral lower projecting pipe 112, which has a main outlet opening 58a and has an integral upper projecting pipe, which has an auxiliary outlet opening 60a. Openings 58a, 60a have respective fluid flow directions denoted by 116 and 118.

End wall 46a supports a tube assembly 120 and supports an outer tube or tubular portion 122, which supports an inner tube 124. Inner tube 124 encloses an inner passage 126. Outer tube 122 and inner tube 124 have an outer passage 128 therebetween. Passages 126, 128 are concentric about axis 38a.

Pipe assembly 120 has a side inlet opening 130, which has a fluid flow direction 131, and which connects to outer passage 128. Pipe assembly 120 also has a bottom inlet opening 132, which has a fluid flow direction 133, and which connects to inner passage 126. Enlarged horn output section 102 has an end face 134. Face 134 is disposed opposite to face of tube 122 forming a gap 138. Likewise, face 134 is also disposed opposite to face 140 of tube 124 forming a gap 142. Gaps 138 and 142 define a sonification or cavitation zone 144 between face 134 and faces 136 and 140.

Pipe assembly 120 also has a lower compression collar 146, which is disposed over inner tube 124, and which is threaded over a lower pipe 148, that is threaded into a T-shaped connector pipe 150, that is threaded over outer tube 122. Pipe assembly 120 also has an upper compression collar 152, which is disposed over outer tube 122, and which is threaded over an upper pipe 154, that is threaded into bottom end wall 46a. Upper compression collar 152 may be loosened first for adjusting the size of gap 138 of outer tube 122. Then, lower compression collar 146 may be subsequently loosened to adjust gap 142. The gaps 138, 142 can be set for optimum processing of fluids from passages 126, 128. In the method or process, fluid flow is identical to the method or process of configuration 10.

A third embodiment of the present general inventive concept which uses the method of the present general inventive concept, is shown in FIG. 6. Parts of third embodiment or cell 10b, which are the same as parts of first embodiment or configuration 10 have the same numerals, but with a subscript “b” added thereto. Configuration 10b has a horn 16b and a cell 20b, which are coaxial along axis 38b. Cell 20b has an outlet opening 58b with a fluid flow direction 62b. Cell 20b has a peripheral wall 40b and a bottom end wall 46b. End wall 46b has an inlet tube 200 with a fluid flow direction 202. Peripheral wall 40b supports a toroidal or ring-shaped collector ring or pipe 204. Pipe 204 has a plurality of relatively small inlet tubes represented graphically by tubes 206, 208. Alternatively, the inlet tubes 206, 208 could be in the form of a manifold or annulus. Horn 16b has a vibration face 210. Inlet pipe 200 has an end face 212. Tubes 206, 208 have respective end faces 214, 216. Faces 210, 212, 214, 216 enclose a sonication zone 218. Collector ring 204 has a tube or pipe 220, which has an inlet opening 222 with a fluid flow direction 224. In this method or process, a primary fluid enters zone 218 from outer tubes 206, 208. A secondary fluid enters zone 218 from inner pipe 200. A fluid mixture, e.g., an oil-based cannabinoid and aqueous fluid mix exits from outlet opening 58b.

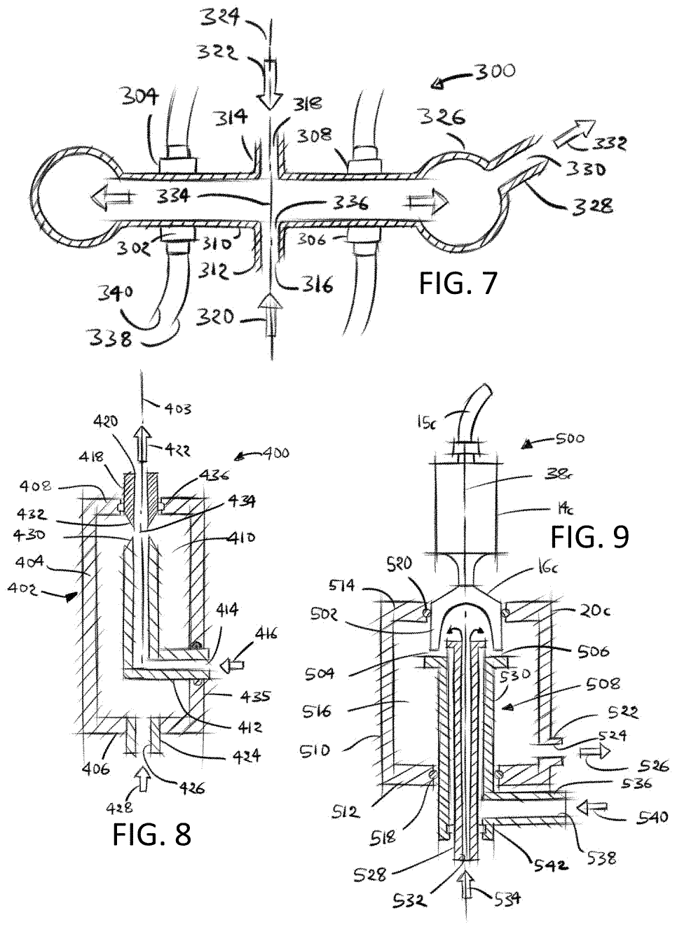

A fourth embodiment, which uses the method of the invention, is shown in FIG. 7. The fourth embodiment or configuration 300 has a plurality of transducers, represented graphically by four transducers 302, 304, 306, 308 which are fitted to a manifold or pipe 310. Manifold 310 has two inlet tubes 312, 314, which have respective openings 316, 318 with respective fluid flow directions 320, 322. Tubes 312, 314 are coaxial along an axis 324. Manifold 310 has a collector ring or pipe 326, which is coaxial with inlet tubes 312, 314. Collector ring 326 has an outlet pipe 328, which has an outlet opening 330 with a fluid flow direction 332. In this method or process, primary fluid from tube 312 and secondary fluid from tube 314 enter a sonication zone 334. Manifold 310 inner surface 336 forms a vibration surface, disposed to surround zone 334. Transducer 302 has typical conductive electrical wires 338, 340, like transducers 304, 306, 308 for supply of power for vibrating manifold inner surface 336. The fluid mixture leaves zone 334, and exits through manifold 310, to collector ring 326, then out through outlet pipe 328.

A fifth embodiment, which uses the method of the present general inventive concept, is shown in FIG. 8. The same cavitational fluid processing action as in the first embodiment can also be obtained in this fifth embodiment or configuration 400 by passing a liquid at a relatively high pressure and velocity past a vibrating reed or sharp edge and configuring the reed or sharp edge in a cylindrical form located concentrically inside or outside of a delivery pipe or tube containing the flow of a second fluid.

Configuration 400 has a vessel 402, which has an axis 403, a peripheral wall 404, a lower end wall 406, and an upper end wall 408, which form a cavity 410. Peripheral wall 404 supports an inlet tube 412, which has an inlet opening 414 with a fluid flow direction 416. Upper end wall 408 has an outlet tube 418, which has an outlet opening 420 with a fluid flow direction 422. Lower end wall 406 has a second inlet tube 424, which has an inlet opening 426 with a fluid flow direction 428. Vessel 402 thus by its nature forms a delivery means for fluid flow direction 416 concentric with fluid flow direction 428. Lower tube 412 has a sharp edge, or vibrating reed type of edge, 430. Upper tube 418 may also have a sharp edge 432. In this method or process, primary fluid flows through inlet tube 424, then through cavity 410, then through an annular space which defines cavitation or sonication zone 434 between sharp edge 430, or vibrating reed edge and other edge 432, then out through outlet tube 418. Secondary fluid flows through lower inlet tube 412, then passes by sharp edge 430 and other edge 432, then flows through upper outlet tube 418. Cavitation of the liquid phase or phases and processing of the fluids occurs in zone 434 by means of vibrations passed radially inwards or outwards of sharp edge or vibrating reed edge 430 and edge 432. The cavitation results, in the case of sharp edges 430, 432, from the passage of fluid at relatively high pressure and velocity past the sharp edges, giving rise to a sudden expansion into cavity 410, which when precisely tuned to the resonant frequency of the cavity results in alternating postive and negative pressure waves being conducted into the liquid phase or phases. Cavitation also results, in the case of vibrtating reed edge 430, from the passage of fluid at relatively high pressure and velocity past the reed edge, giving rise to vibration of the edge at a high frequency and conduction of such vibration into the liquid phase or phases. The edge 430 has a face which vibrates radially and which is adjacent to the sonication zone 434. Fluids are retained in cavity 410 by seals 435, 436.

A sixth embodiment, which uses the method of the present general inventive concept, is shown in FIG. 9. Parts of sixth embodiment or configuration 500 which are like parts of the first embodiment 10 have the same numerals but with a subscript “c” added thereto. Configuration 500 has a converter 14c with a cable 15c, a parabolic or bell-shaped horn 16c and a housing or vessel or cell 20c. Converter 14c has an axis 38c. Converter 16c has substantially the same structure as converter 14 of first embodiment 10. Ring horn 16c has the same structure as horn 16, but ring horn 16c has an internally-relieved bell-shaped lower portion or bell portion 502. Bell portion 502 has a ring-shaped radiation face 504. Face 504 forms an upper part of an annular sonication zone 506. Cell 20c has a pipe assembly 508. Cell 20c has a peripheral wall 510, a lower end wall 512, and an upper end wall 514 enclosing a cavity 516. Lower wall 512 has a seal ring 518, which engages pipe assembly 508. Upper wall 514 has a seal ring 520, which engage bell-shaped lower portion 502. Peripheral wall 510 has an outlet pipe 522, which has an outlet opening 524 with a fluid flow direction 526. Pipe assembly 508 has an inner tube 528 and an outer tube 530, coaxial along axis 38c. Inner tube 528 has an inlet opening 532 with a flow direction 534. Outer tube 530 has an inlet pipe 536 which has an inlet opening 538 with a flow direction 540. Outer tube 530 has a seal ring 542, which engages inner tube 528. In this method or process, primary fluid flows between outer tube 530 and inner tube 528. Secondary fluid flows through inner tube 528. The primary and secondary fluids mix radially outwardly in, and pass through, annular sonication or cavitation zone 506, then pass into cavity 516, and exit at outlet pipe 522.

Thus, the invention provides an ultrasonic fluid processing method for cannabis and products derived therefrom, including the steps of providing a sonication zone, providing a vibrational surface within said sonication zone, providing a cannabinoid oil in a first fluid into the sonication zone, providing a second fluid material into the sonication zone which is generally immiscible with the cannabinoid oil, and energizing the vibrational surface to cause ultrasonic cavitation and thereby break up the cannabinoid oil into nano-particles in the second fluid material creating an emulsion. The vibrational surface and sonication zone are in a sealed cavity having a first fluid passage receiving the first fluid adjacent the vibrational surface and a second fluid passage receiving the second fluid about the first fluid in the sonication zone, and an outlet. In a preferred embodiment, the second fluid includes water. The first fluid further can includes a terpene or a flavonoid.

The above described embodiments are set forth by way of example and are not for the purpose of limiting the scope of the present general inventive concept. It will be readily apparent that obvious modifications, derivations and variations can be made to the embodiments without departing from the scope of the invention. Accordingly, the claims appended hereto should be read in their full scope including any such modifications, derivations and variations.

What is claimed is:

1. An ultrasonic fluid processing method for cannabis and products derived therefrom, including the steps of:
providing a sonication zone;
providing a vibrational surface within said sonication zone;
providing a cannabinoid oil in a first fluid into said sonication zone;
providing a second fluid material into said sonication zone which is generally immiscible with said cannabinoid oil; and
energizing said vibrational surface to cause ultrasonic cavitation and thereby break up said cannabinoid oil into nano-particles in said second fluid material creating an emulsion.

2. The ultrasonic fluid processing method for cannabis and products derived therefrom of claim 1, wherein said second fluid includes water.

3. The ultrasonic fluid processing method for cannabis and products derived therefrom of claim 1, wherein said first fluid further includes a terpene.

4. The ultrasonic fluid processing method for cannabis and products derived therefrom of claim 1, wherein said first fluid further includes a flavonoid.

5. The ultrasonic fluid processing method for cannabis and products derived therefrom of claim 1, wherein said vibrational surface and sonication zone are in a sealed cavity having a first fluid passage receiving said first fluid adjacent said vibrational surface and a second fluid passage receiving said second fluid about said first fluid in said sonication zone, and an outlet.

6. The method of claim 5, wherein said second fluid passage is concentric about said first fluid passage.

7. The ultrasonic fluid processing method for cannabis and products derived therefrom of claim 1, wherein said vibrational surface and sonication zone are configured to form a cup-like cavity with a sealable opening at one end for receiving said first and said second fluids and to permit immediate consumption of the sonicated fluids therefrom.

8. The ultrasonic fluid processing method for cannabis and products derived therefrom of claim 1, wherein said vibrational surface comprises a cylindrical horn.

9. The method of claim 8, wherein said cylindrical horn is stepped.

10. The method of claim 8, wherein said cylindrical horn is parabolic.

11. The ultrasonic fluid processing method for cannabis and products derived therefrom of claim 1, wherein said vibrational surface is oscillated in the range of 19 to 25 kilohertz.

12. The ultrasonic fluid processing method for cannabis and products derived therefrom of claim 1, wherein said vibrational surface is oscillated in the range of 39 to 50 kilohertz.

13. The ultrasonic fluid processing method for cannabis and products derived therefrom of claim 1, wherein said vibrational surface comprises a piezoelectric transducer and high-frequency generator.

14. The method of claim 13, wherein said high-frequency generator produces ultrasonic oscillations in the range of 30 to 70 watts.

15. The method of claim 13, wherein said high-frequency generator produces ultrasonic oscillations in the range of 70 to 150 watts.
